(19) United States
(12) Patent Application Publication
(10) Pub. No.: US 2012/0083620 A1
(43) Pub. Date: Apr. 5, 2012

(54) METHOD FOR HYDROSILYLATING

(75) Inventor: Wolfgang Ziche, Burghausen (DE)

(73) Assignee: WACKER CHEMIE AG, Munich (DE)

(21) Appl. No.: 13/376,773

(22) PCT Filed: Jun. 21, 2010
(86) PCT No.: PCT/EP2010/058714

§ 371 Date: Dec. 7, 2011

(30) Foreign Application Priority Data
Jun. 25, 2009 (DE) 10 2009 027 215.1

(51) Int. Cl. C07F 7/12

(52) U.S. Cl. 556/478

(57) ABSTRACT

Minimization of byproducts in hydrosilylation reactions is achieved by use of a catalyst system which contains a platinum (O) complex catalyst and an oranic amine oxide and/or hydrate thereof.

The invention relates to a process for preparing organosilicon compounds by reacting olefins with a compound containing SiH groups in the presence of a platinum catalyst and at least one amine oxide.

Organofunctional silanes are of great economic interest and nowadays encompass many industrial fields of use. 3-chloropropylchlorosilanes, in particular, are important intermediates, in the preparation of organofunctional silanes. They are generally prepared by hydrosilylation of allyl chloride. 3-chloropropyltrichlorosilane and 3-chloropropylmethyldichlorosilane can be used to prepare, for example, 3-chloropropyltrialkoxysilanes, 3-chloropropylmethyldialkoxysilanes, 3-aminopropyltrialkoxysilanes, 3-aminopropylmethyldialkoxysilanes, N-aminoethyl-3-aminopropyltrialkoxysilanes, N-aminoethyl-3-aminopropylmethyldialkoxysilanes, 3-cyanopropylalkoxysilanes, 3-glycidyloxypropylalkoxysilanes, 3-methylacryloxypropylakoxysilanes, to name only a few examples.

The addition of Si-bonded hydrogen onto aliphatic multiple bonds has been known for a long time and is referred to as hydrosilylation. This reaction is promoted, for example, by homogeneous and heterogeneous catalyst, in particular by means of platinum catalysts.

Such platinum catalysts can in the case of heterogeneously catalyzed reactions be platinum metal, in particular very finely divided platinum on a support such as activated carbon or in the case of homogeneous catalysis can be, for example, hexachloroplatinic acid, alcohol-modified hexachloroplatinic acid, olefin complexes of hexachloroplatinic acid, vinylsiloxane complexes of hexachloroplatinic acid or of platinum. Complexing reagents are often added to a catalyst system in order to increase selectivity and reactivity, and in some cases an improved solubility of the platinum compound is also obtained at the same time.

EP 0 573 282 A1 discloses the use of H₂PtCl₆ in 2-ethylhexanal and addition of m-xylene hexafluoride. EP 0 263 673 A2 teaches the preparation of 3-chloropropyltrichlorosilane by hydrosilylation using hexachloroplatinic acid dissolved in isopropanol (Speier catalyst) and the addition of N,N-dimethylacetamide. EP 0032377 B1 discloses the use of platinum catalysts complexed by secondary amines for the hydrosilylation of allyl chloride.

The hydrosilylation reaction of allyl chloride and methyldichlorosilane generally results in formation of two undesirable by-products: methyltrichlorosilane and dichloromethylpropylsilane. The latter can be used in an economically advantageous way only with difficulty.

The enumeration of examples of additives to metal complex catalysts with the objective of positively influencing the course of homogeneously catalyzed reactions could be continued virtually at will. Karstedt catalysts (Pt(0) complexes) have also been used for many years for hydrosilylations. Thus, for example, DE-A 19 41 411 and U.S. Pat. No. 3,775,452 disclose platinum catalysts of the KARSTEDT type. In general, this type of catalyst has a high stability, especially in an oxidizing matrix, high effectiveness and a low isomerization effect on C frameworks. EP 0 838 467 A1 discloses a process for preparing silanes bearing fluoroalkyl groups using a Pt(0) complex catalyst dissolved in xylene.

Experiments show that in the hydrosilylation reaction of, for example, allyl chloride with methyldichlorosilane at a molar starting material ratio of 1:1 and with use of a KARSTEDT catalyst, a yield of 3-chloropropylmethyldichlorosilane of not more than 49 mol % is obtained.

The invention provides a process for the addition of Si-bonded hydrogen onto aliphatic carbon-carbon multiple bonds by reaction of

(A) compounds having aliphatic carbon-carbon multiple bonds with

(B) organosilicon compounds having Si-bonded hydrogen atoms in the presence of

(C) a Pt(0) complex catalyst and

(D) at least one organic amine N-oxide and/or hydrate thereof and optionally

(E) solvent.

The compounds (A) used according to the invention can be silicon-free organic compounds having aliphatically unsaturated groups or organosilicon compounds having aliphatically unsaturated groups.

Examples of organic compounds which can be used as component (A) in the process of the invention are all aliphatically unsaturated compounds which have hitherto also been used in hydrosilylation reactions, preferably optionally substituted alkenes and alkynes.

The component (A) is particularly preferably made up of unsaturated aliphatic compounds of the general formula

X-(CH₂)ₙ—C(R¹)═CH₂ (I),

where X is a hydrogen atom, halogen atom such as a chlorine atom or bromine atom, cyano radical, nitrile radical (—CN), fluoroalkyl radical CₘF₂ₘ₊₁ where m is from 1 to 20, radicals of the formula RO—(CH₂—CHR—O)_{y}— where y is from 0 to 30, 2,3-epoxypropyl-1 radical or CH₂═CR′—COO— radical,

the radicals R can be identical or different and are each a hydrogen atom or a linear or branched C1-C4-alkyl group,

R′ is a hydrogen atom or a linear or branched C1-C4-alkyl group,

R¹ is a hydrogen atom or a linear or branched C1-C4-alkyl group and

n is 0 or an integer from 1 to 3.

The radical X is preferably a halogen atom, with particular preference being given to a chlorine atom.

The radical R¹ is preferably a hydrogen atom or a methyl radical, particularly preferably a hydrogen atom.

The radical R′ is preferably a hydrogen atom or a methyl radical, particularly preferably a methyl radical.

n is preferably 1.

The compounds of the formula (I) are particularly preferably 3-chloro-1-propene, which is also referred to as allyl chloride, or 3-chloro-2-methyl-1-propene, also referred to as methallyl chloride.

Furthermore, it is possible to use aliphatically unsaturated organosilicon compounds such as vinyl-terminated organopolysiloxanes as constituent (A) in the process of the invention, but this is not preferred.

The compounds used as component (B) in the process of the invention can be any previously known organosilicon compounds which have at least one Si-bonded hydrogen atom, e.g. SiH-functional silanes and siloxanes.

Component (B) preferably comprises hydrogensilanes of the general formula

H_{4-a-b}SiR²ₐY_{b} (II),

where

the radicals R² can be identical or different and are each optionally substituted hydrocarbon radicals which are free of aliphatic carbon-carbon multiple bonds, the radicals Y can be identical or different and are each a chlorine atom, bromine atom, methoxy radical or ethoxy radical,

a is 0, 1, 2 or 3 and

b is 0, 1, 2 or 3, with the proviso that the sum a+b is 1, 2 or 3, particularly preferably 3.

The radical Y is preferably a chlorine atom.

The radicals R² are preferably linear, branched or cyclic alkyl groups having from 1 to 16 carbon atoms or aryl groups, particularly preferably the methyl radical.

The hydrogen silanes of the formula (II) are preferably trichlorosilane, methyldichlorosilane or dimethylchlorosilane.

In the process of the invention, constituent (B) is preferably used in such an amount that the molar ratio of aliphatically unsaturated groups of the constituent (A) to SiH groups of the constituent (B) is from 20:1 to 1:1, particularly preferably from 10:1 to 2:1, in particular from 3:1 to 2:1.

The components (A) and (B) used according to the invention are commercial products or can be prepared by methods customary in chemistry.

In the process of the invention, all platinum(0) complexes which have hitherto also been used for the addition of Si-bonded hydrogen onto aliphatically unsaturated compounds can be used as catalyst component (C).

Preference is given to using a Pt(0) complex catalyst, particularly preferably a Pt(0) complex catalyst of the KARSTEDT type, as component (C) in the process of the invention. Platinum catalysts of the Karstedt type have been known for a long time and are described, for example, in DE-A 19 41 411 and U.S. Pat. No. 3,775,452, which are incorporated by reference into the disclosure content of the present patent application. In particular, component (C) is the KARSTEDT catalyst platinum(0)-divinyltetramethyldisiloxane of the formula Pt₂[(CH₂═CH) (CH₃)₂Si]₂O₃.

The catalyst (C) used in the process of the invention contains platinum in an amount of preferably from 0.01 to 20% by weight, particularly preferably from 0.1 to 10% by weight, in particular from 0.5 to 5% by weight.

In the process of the invention, catalyst (C) can be used as such or preferably in a mixture with solvents (E). Examples of solvents which may be used and are preferably inert toward the component (B) are aromatic hydrocarbons, preferably xylene or toluene, ketones, preferably acetone, methyl ethyl ketone or cyclohexanone, alcohols, preferably methanol, ethanol, n- or i-propanol, or the desired target product.

If component (C) is to be used as solvent mixture, the content of Pt(0) in the mixture is preferably from 0.1 to 10% by weight, particularly preferably from 0.5 to 5% by weight, in particular from 1 to 3% by weight, very particularly preferably 1% by weight.

In the process of the invention, catalyst (C) is, in each case based on elemental platinum, used in a molar ratio to the unsaturated groups of the aliphatic compound (A) of preferably from 1:1000 to 1:70 000, particularly preferably from 1:10 000 to 1:60 000, in particular from 1:15 000 to 1:40 000.

The preferably molar ratio of the platinum of the catalyst (C) used, based on the H-Si groups of the component (B), is derived from the ratios of the components (A) and (B).

The amine N-oxides and/or hydrates thereof (D) used according to the invention have a ≡N═O group. They can be aliphatic amine N-oxides or aromatic amine N-oxides, with the nitrogen of the ≡N═O group also being able to be part of an aromatic system, although this is not preferred.

Examples of aromatic amine N-oxides (D) in which the nitrogen of the ≡N═O group is part of an aromatic system are 2-, 3- or 4-picoline N-oxides, isoquinoline N-oxide, pyridine N-oxide, pyrazine N-oxide, pyridimine N-oxide, 3,5-dichloropyridine N-oxide, 2-chloropyridine N-oxide hydrochloride, nicotinamide N-oxide, 3,5-dimethylpyridine N-oxide, 3-hydroxypyridine N-oxide, 4-methoxypyridine N-oxide hydrate and quinoxaline N-oxide.

Examples of aliphatic amine N-oxides and aromatic amine N-oxides in which the nitrogen of the ≡N═O group is not part of an aromatic system are N,N-dimethyldodecylamine N-oxide, N,N-dimethyldecylamine N-oxide, trimethylamine N-oxide, trimethylamine N-oxide dihydrate, N-methylmorpholine N-oxide, N-methylmorpholine N-oxide monohydrate, N,N-dimethylheptylamine N-oxide hydrate, 3,3,5,5-tetramethylpyrroline N-oxide and 5-(2,2-dimethyl-1,3-propoxycyclophosphoryl)-5-methyl-1-pyrroline N-oxide.

Component (D) is preferably made up of amine N-oxides of the general formula

R³_{z}N═O (III),

where

the radicals R³ can be identical or different and are each a hydrogen atom or an optionally substituted hydrocarbon radical which may be interrupted by heteroatoms and z is 1, 2 or 3,

with the proviso that not more than two radicals R³ in formula (III) are hydrogen atoms and the radicals R³, represent a total of three bonds to the nitrogen, and/or hydrates thereof.

Thus, z is 3 when the radicals R³ each have one bond to the nitrogen, is 2 when one radical R³ has one bond to the nitrogen and a further radical R³ has two bonds and is 1 when the radical R³ has three bonds to the nitrogen.

Examples of radicals R³ having one bond to the nitrogen are a hydrogen atom, alkyl radicals such as methyl, ethyl, n-propyl, isopropyl, 1-n-butyl, 2-n-butyl, isobutyl, tert-butyl, n-pentyl, isopentyl, neopentyl, tert-pentyl radicals; hexyl radicals such as the n-hexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl radicals and methylcyclohexyl radicals; alkenyl radicals such as the vinyl, 1-propenyl and 2-propenyl radicals; aryl radicals such as the phenyl, naphthyl, anthryl and phenanthryl radicals; alkaryl radicals such as o-, m-, p-tolyl radicals; xylyl radicals and ethylphenyl radicals; and aralkyl radicals such as the benzyl radical, the α- and the β-phenylethyl radical.

Examples of substituted radicals R³ having one bond to the nitrogen are haloalkyl radicals such as the 3,3,3-trifluoroprop-1-yl radical, the 1,1,1,3,3,3-hexafluoroprop-2-yl radical and the heptafluoroprop-2-yl radical, haloaryl radicals such as the o-, m- and p-chlorophenyl radicals and the 2-methoxyethyl radical, the 2-methoxyprop-1-yl radical and also the 2-(2-methoxyethoxy)ethyl radical.

Examples of radicals R³ having two bonds to the nitrogen are the —CH₂—CH₂—O—CH₂—CH₂ radical and the —C(CH₃)₂—CH₂—C(CH₃)₂—CH═ radical.

Examples of radicals R³ having three bonds to the nitrogen are the ≡CH—CH═CH—CH═CH radical, the ═CH—CH═CH—CH═C(CH₃) radical, the ═CH—CH═CH—C(CH₃)═CH radical and the ═CH—CH═C(CH₃)—CH═CH radical.

Radicals R³ are preferably radicals having one or two bonds to the nitrogen, particularly preferably linear, branched or cyclic alkyl groups having from 1 to 16 carbon atoms or monovalent, optionally substituted aryl groups having from 2 to 8 carbon atoms, and the —CH₂—CH₂—O—CH₂—CH₂ radical, in particular methyl, ethyl, lauryl radicals, and the —CH₂—CH₂—O—CH₂—CH₂ radical having two bonds to the nitrogen.

Examples of compounds (D) of the formula (III) having z equal to 3 which are used according to the invention are N,N-dimethyldodecylamine N-oxide, commercially available, for example, as aqueous solution from Lonza under the trade name Barlox® 12, N,N-dimethyldecylamine N-oxide and trimethylamine N-oxide and also hydrates thereof.

Examples of compounds (D) of the formula (III) having z equal to 2 which are used according to the invention are N-methylmorpholine N-oxide, commercially available, for example, from Huntsman or BASF AG, and also hydrates thereof.

Examples of compounds (D) of the formula (III) having z equal to 1 which are used according to the invention are all aromatic N-oxides such as 2-, 3- or 4-picoline N-oxides, isoquinoline N-oxide, pyridine N-oxide, pyrazine N-oxide, pyrimidine N-oxide, 3,5-dichloropyridine N-oxide, 2-chloropyridine N-oxide hydrochloride, nicotinamide N-oxide, 3,5-dimethylpyridine N-oxide, 3-hydroxypyridine N-oxide, 4-methoxypyridine N-oxide hydrate and quinoxaline N-oxide and also hydrates thereof.

The compounds (D) used according to the invention are preferably N-methylmorpholine N-oxide or N,N-dimethyldodecylamine N-oxide or a hydrate thereof, with N-methylmorpholine N-oxide or a hydrate thereof being particularly preferred.

The components (D) used according to the invention are commercial products or can be prepared by methods customary in chemistry.

In the process of the invention, component (D) and catalyst (C) are used in a molar ratio of preferably from 10:1 to 1:10, particularly preferably 1:1, in each case based on elemental platinum.

In addition to the components (A), (B), (C), (D) and optionally (E), it is possible to use further components in the process of the invention, but this is not preferred.

From a process engineering point of view, particularly in the case of a continuous process, it can be advantageous to fill the plant before the beginning of the reaction according to the invention with the desired target product, so that the target product performs the function of the solvent component (E). This is advantageous in controlling the exothermic reaction and has the advantage in the work-up of the reaction mixture that no additional component interferes in the separation. In batch operation, the initial charge of the target product likewise represents an opportunity of controlling the exothermic reaction when the reactants are introduced; on the other hand, not too much target product should be initially charged in order to optimize the space-time yield. The proportion of initially charged target product is preferably from 5 to 50%, particularly preferably from 10 to 30%, in particular from 15 to 25%, of the total mass at the end of the reaction.

Preference is given to using no materials in addition to components (A) to (E) in the process of the invention.

The components used in the process of the invention can in each case be one type of such a component or a mixture of at least two types of a respective component.

In the process of the invention, the individual components can be mixed with one another in any manner known per se.

For example, the organic amine N-oxide (D) can firstly be added to the Pt(0) complex catalyst (C) in a mixture with the organic solvent (E) and the resulting amine N-oxide-containing catalyst solution can subsequently be added to the mixture of compound (B) containing an SiH group and component (A) in the process of the invention. In another process variant, however, it is possible to initially charge one of the two starting components or a mixture thereof, add the Pt(0) catalyst (C) mixed with the organic solvent (E) and subsequently, preferably with good mixing, add the amine N-oxide (D). Furthermore, it is possible to initially charge one of the two starting components or a mixture thereof, add the amine N-oxide (D) and subsequently introduce the Pt(0) catalyst solution into the reaction mixture. It is likewise possible to introduce one of the starting components, preferably component (B), into the mixture of the remaining components.

The process of the invention is carried out at a temperature in the range of preferably from 10 to 200° C., particularly preferably in the range from 20 to 200° C., in particular from 30 to 150° C. Furthermore, the process of the invention is carried out at a pressure in the range from 1 to 50 bar (abs.), preferably at from 1 to 10 bar (abs.), in particular at the pressure of the surrounding atmosphere.

The process of the invention is preferably carried out under a protective gas atmosphere, e.g. under nitrogen or argon.

The process of the invention is preferably carried out with exclusion of moisture.

The process of the invention can be operated batchwise or continuously, with the continuous mode of operation being preferred.

The products are obtained immediately after the end of the reaction according to the invention with a conversion of preferably at least 95%, and the separation of the reaction product from the catalyst system composed of (C) and (D) and optionally (E) is preferably carried out by distillation.

The products prepared according to the invention can be used for all purposes for which the organosilanes known hitherto have been used. They can also be processed further in any desired way. Thus, in the case of chlorosilane products, the Si-bonded chlorine atoms can be esterified in a manner known per se with an alcohol, giving alkoxysilanes. The alcohols used for the esterification according to the invention are preferably methanol, ethanol or 2-methoxyethanol.

In one variant of the process of the invention, functional organosilanes, in particular 3-chloropropyltrichlorosilane, 3-chloropropyltrialkoxysilanes, 3-chloropropylmethyldichlorosilane and 3-chloropropylmethyldialkoxysilanes, where alkoxy is preferably methoxy or ethoxy, can be prepared by reacting preferably 3-chloro-1-propene with a hydrogen chlorosilane, in particular with trichlorosilane or methyldichlorosilane, in the presence of a platinum(0) complex catalyst with addition of at least one organic amine N-oxide, with the catalyst and the amine N-oxide being used together in a solvent, isolating the hydrosilylation product from the reaction mixture and esterifying this product with an alcohol in a manner known per se to give a 3-chloropropylalkoxysilane. As alcohol for the esterification of the hydrosilylation product, preference is given to using methanol, ethanol or 2-methoxyethanol.

In a preferred process variant, the solvent (E), e.g. chloropropylmethyldichlorosilane, is placed in a reaction vessel, a mixture of platinum(0) complex catalyst (C), component (D), e.g. trimethylamine N-oxide, is subsequently added and the contents of the reaction vessel are mixed well. The reaction mixture obtained in this way is then preferably heated and a mixture of components (A), e.g. allyl chloride, and (B), e.g. methyldichlorosilane, is preferably introduced until the boiling point of the mixture has been reached and reflux commences. The boiling point is determined by the type of reaction components (starting materials). The occurrence of the hydrosilylation reaction generally becomes noticeable as a result of an increase in the temperature in the reaction vessel because the addition is exothermic. The reaction of the starting materials is generally monitored by regular sampling and GC determination of the constituents. As soon as an appreciable increase in the content of the desired reaction product in the reaction mixture is no longer observed, the removal of the low-boiling constituents of the reaction mixture, preferably by distillation, can be commenced, optionally under reduced pressure. A fine distillation of the product can subsequently be carried out, and this, too, is frequently carried out under reduced pressure.

The process of the invention has the advantage that it is simple to carry out and hydrolysis products such as 3-chloropropylmethyldichlorosilane can be prepared in an excellent yield in an economical way.

Furthermore, the process of the invention has the advantage that due to the excellent effectiveness of the catalyst used in combination with the organic amine N-oxide, the addition of the SiH component onto the olefinically unsaturated component generally occurs so quickly that secondary reactions are largely suppressed and the yield and purity of the desired product are very high.

The process of the invention has the further advantage that it has a high selectivity and valuable SiH components can be utilized effectively.

Furthermore, the process of the invention has the advantage that only small amounts of component (D) have to be used, which firstly has economic advantages and secondly has no adverse effect on isolation of the product.

In the examples described below, all parts and percentages are, unless indicated otherwise, by weight. Unless indicated otherwise, the examples below are carried out at the pressure of the surrounding atmosphere, i.e. at about 1000 hPa, and at room temperature, i.e. at about 20° C., or at a temperature which is established on combining the reactants at room temperature without additional heating or cooling.

The selectivities reported in the following examples relate to the reactions shown below:

HSiCl₂(CH₃)+H₂C═CH—CH₂—Cl→[SiCl₂(CH₃)]—CH₂—CH₂—CH₂—Cl (1)

HSiCl₂(CH₃)+H₂C═CH—CH₂—Cl→H₂C═CH—CH₃+SiCl₃(CH₃) (2)

HSiCl₂(CH₃)+H₂C═CH—CH₃→[SiCl₂(CH₃)]—CH₂—CH₂—CH₃ (3)

S1: Selectivity in respect of secondary reaction (2)

S1=mol of product/(mol of product+mol of by-product)*100%

S2: Selectivity in respect of subsequent reaction (3)

S2=mol of subsequent product/(mol of by-product+mol of subsequent product)*100%

### COMPARATIVE EXAMPLE 1

### Analogous to U.S. Pat. No. 6,326,506

40 g of chloropropylmethyldichlorosilane, 0.85 g of triethyl phosphate (ten times the molar amount of platinum) and 0.25 g of a toluene solution of platinum (0)-divinyltetramethyldisiloxane complex (0.4% by weight of Pt) are placed under an argon atmosphere in a 250 ml three-neck glass flask provided with reflux condenser, magnetic stirrer bar, thermometer and dropping funnel and heated to 80° C. 80 g of allyl chloride (1.045 mol) and 62 g of dichloromethylsilane (0.54 mol) are added dropwise as a mixture over a period of 2.5 hours in such a way that the reaction mixture boils gently. After the addition is complete, the temperature of the reaction mixture is maintained at 73° C. for another one hour. The reaction solution is analyzed by gas chromatography. The results are shown in table 1.

### COMPARATIVE EXAMPLE 2

### Analogous to EP-B 32 377

40 g of chloropropylmethyldichlorosilane, 0.031 g of a catalyst prepared as described in EP 32377 (4.1% by weight of Pt) are placed under an argon atmosphere in a 250 ml three-neck glass flask provided with reflux condenser, magnetic stirrer bar, thermometer and dropping funnel and heated to 80° C. 76.53 g of allyl chloride (1.0 mol) and 57.5 g of dichloromethylsilane (0.50 mol) are added dropwise as a mixture over a period of 3.75 hours in such a way that the reaction mixture boils gently. After the addition is complete, the temperature of the reaction mixture is maintained at 60° C. for another one hour. The reaction solution is analyzed by gas chromatography. The results are shown in table 1.

### COMPARATIVE EXAMPLE 3

### Analogous to EP-B 263 673

40 g of chloropropylmethyldichlorosilane, 0.07 g of a catalyst solution (0.4 g of hexachloroplatinic acid (40% by weight of Pt), 4.9 g of isopropanol, 0.068 g of dimethylacetamide) are placed under an argon atmosphere in a 250 ml three-neck glass flask provided with reflux condenser, magnetic stirrer bar, thermometer and dropping funnel and heated to 60° C. 82.65 g of allyl chloride (1.08 mol) and 62 g of dichloromethylsilane (0.54 mol) are added dropwise as a mixture over a period of 2 hours 50 minutes in such a way that the reaction mixture boils gently. After the addition is complete, the temperature of the reaction mixture is maintained at 63° C. for another one hour. The reaction solution is analyzed by gas chromatography. The results are shown in table 1.

### COMPARATIVE EXAMPLE 4

40 g of chloropropylmethyldichlorosilane and 0.25 g of a toluene solution of platinum(0) divinyltetramethyldisiloxane complex (0.4% by weight of Pt) are placed under an argon atmosphere in a 250 ml three-neck glass flask provided with reflux condenser, magnetic stirrer bar, thermometer and dropping funnel and heated to 80° C. 76.53 g of allyl chloride (1.0 mol) and 57.5 g of dichloromethylsilane (0.50 mol) are added dropwise as a mixture over a period of 3 hours in such a way that the reaction mixture boils gently. After the addition is complete, the temperature of the reaction mixture is maintained at 70° C. for another one hour. The reaction solution is analyzed by gas chromatography.

### EXAMPLE 1

40 g of chloropropylmethyldichlorosilane, 0.564 g of 4-methylmorpholine 4-oxide, 97% strength (0.00467 mol, ten times the molar amount of platinum, does not dissolve completely in the reaction mixture) and 0.25 g of a toluene solution of platinum(0)-divinyltetramethyldisiloxane complex (0.4% by weight of Pt) are placed under an argon atmosphere in a 250 ml three-neck glass flask provided with reflux condenser, magnetic stirrer bar, thermometer and dropping funnel and heated to 80° C. 76.53 g of allyl chloride (1.0 mol) and 57.5 g of dichloromethylsilane (0.50 mol) are added dropwise as a mixture over a period of 3 hours in such a way that the reaction mixture boils gently. After the addition is complete, the temperature of the reaction mixture is maintained at 70° C. for another one hour. The reaction solution is analyzed by gas chromatography. The results are shown in table 1.

### EXAMPLE 2

40 g of chloropropylmethyldichlorosilane, 0.11 g of 4-methylmorpholine 4-oxide, 97% strength (0.9108 mmol, two times the molar amount of platinum) and 0.25 g of a toluene solution of platinum(0)-divinyltetramethyldisiloxane complex (0.4% by weight of Pt) are placed under an argon atmosphere in a 250 ml three-neck glass flask provided with reflux condenser, magnetic stirrer bar, thermometer and dropping funnel and heated to 80° C. 76.53 g of allyl chloride (1.0 mol) and 57.5 g of dichloromethylsilane (0.50 mol) are added dropwise as a mixture over a period of 3 hours in such a way that the reaction mixture boils gently. After the addition is complete, the temperature of the reaction mixture is maintained at 70° C. for another one hour. The reaction solution is analyzed by gas chromatography. The results are shown in table 1.

### EXAMPLE 3

40 g of chloropropylmethyldichlorosilane, 0.26 g of trimethylamine N-oxide dihydrate (0.00234 mol) and 0.25 g of a toluene solution of platinum(0)-divinyltetramethyldisiloxane complex (0.4% by weight of Pt) are placed under an argon atmosphere in a 250 ml three-neck glass flask provided with reflux condenser, magnetic stirrer bar, thermometer and dropping funnel and heated to 80° C. 76.53 g of allyl chloride (1.0 mol) and 57.5 g of dichloromethylsilane (0.50 mol) are added dropwise as a mixture over a period of 3 hours in such a way that the reaction mixture boils gently. After the addition is complete, the temperature of the reaction mixture is maintained at 70° C. for another one hour. The reaction solution is analyzed by gas chromatography. The results are shown in table 1.

TABLE 1

| | | Residual | | |
|---|---|---|---|---|
| | Yield | dichloro- | | |
| | [%] | methylsilane [%] | S1 | S2 |
| Comparative example 1 | 66 | 0.018 | 76.13 | 6.67 |
| Comparative example 2 | 44 | 6.5 | 67.7 | 4.55 |
| Comparative example 3 | 61.1 | 0.048 | 75.17 | 12.59 |
| Comparative example 4 | 0 | 77.78 | 0 | 0 |
| Example 1 | 59.6 | 0.197 | 70.64 | 1.75 |
| Example 2 | 59.26 | 0.08 | 70.02 | 2.00 |
| Example 3 | 55.56 | 0.09 | 69.57 | 1.50 |

The results show that a good yield of hydrosilylation product with a simultaneous improvement in the selectivities can be achieved by means of the process of the invention. In particular, in the preparation according to the invention of 3-chloropropylmethyldichlorosilane from methyldichlorosilane, the formation of propylmethyldichlorosilane from a competing reaction is suppressed to a great extent.

1-9. (canceled)

10. A process for the addition of Si-bonded hydrogen onto aliphatic carbon-carbon multiple bonds, comprising reacting
(A) compounds having aliphatic carbon-carbon multiple bonds with
(B) organosilicon compounds having Si-bonded hydrogen atom(s) in the presence of
(C) a Pt(0) complex catalyst and
(D) at least one organic amine N-oxide and/or hydrate thereof and optionally
(E) solvents.

11. The process of claim 10, wherein component (A) comprises unsaturated aliphatic compounds of the formula
X-(CH₂)ₙ—C(R¹)═CH₂ (I),
where X is a hydrogen atom, halogen atom, cyano radical, nitrile radical (—CN), fluoroalkyl radical CₘF₂ₘ₊₁ where m is from 1 to 20, radicals of the formula RO—(CH₂—CHR—O)_{y}— where y is from 0 to 30, 2,3-epoxypropyl-1 radical or CH₂═CR′—COO— radical, the radicals R are identical or different and are each a hydrogen atom or a linear or branched C1-C4-alkyl group,
R′ is a hydrogen atom or a linear or branched C1-C4-alkyl group,
R¹ is a hydrogen atom or a linear or branched C1-C4-alkyl group and
n is 0 or an integer from 1 to 3.

12. The process of claim 10, wherein component (A) is 3-chloro-1-propene or 3-chloro-2-methyl-l-propene.

13. The process of claim 11, wherein component (A) is 3-chloro-1-propene or 3-chloro-2-methyl-l-propene.

14. The process of claim 10, wherein component (B) comprises hydrogensilane(s) of the formula
H_{4-a-b}SiR²ₐY_{b} (II),
where
the radicals R² are identical or different and are each optionally substituted hydrocarbon radicals which are free of aliphatic carbon-carbon multiple bonds,
the radicals Y are identical or different and are each a chlorine atom, bromine atom, methoxy radical or ethoxy radical,
a is 0, 1,2 or 3 and
b is 0, 1, 2 or 3, with the proviso that the sum a+b is 1, 2 or 3.

15. The process of claim 11, wherein component (B) comprises hydrogensilane(s) of the formula
H_{4-a-b}SiR²ₐY_{b} (II),
where
the radicals R² are identical or different and are each optionally substituted hydrocarbon radicals which are free of aliphatic carbon-carbon multiple bonds,
the radicals Y are identical or different and are each a chlorine atom, bromine atom, methoxy radical or ethoxy radical,
a is 0, 1,2 or 3 and
b is 0, 1, 2 or 3, with the proviso that the sum a+b is 1, 2 or 3.

16. The process of claim 12, wherein component (B) comprises hydrogensilane(s) of the formula
H_{4-a-b}SiR²ₐY_{b} (II),
where
the radicals R² are identical or different and are each optionally substituted hydrocarbon radicals which are free of aliphatic carbon-carbon multiple bonds,
the radicals Y are identical or different and are each a chlorine atom, bromine atom, methoxy radical or ethoxy radical,
a is 0, 1,2 or 3 and
b is 0, 1, 2 or 3, with the proviso that the sum a+b is 1, 2 or 3.

17. The process of claim 10, wherein component (B) is trichlorosilane, methyldichlorosilane or dimethylchlorosilane.

18. The process of claim 10, wherein component (D) comprises amine N-oxides of the formula
R³_{z}N═O (III),
where
the radicals R³ are identical or different and are each a hydrogen atom or an optionally substituted hydrocarbon radical which may be interrupted by heteroatoms and
z is 1, 2 or 3,
with the proviso that not more than two radicals R³ in formula (III) are hydrogen atoms and the radicals R³_{z} represent a total of three bonds to the nitrogen, and/or hydrates thereof.

19. The process of claim 11, wherein component (D) comprises amine N-oxides of the formula
R³_{z}N═O (III),
where
the radicals R³ are identical or different and are each a hydrogen atom or an optionally substituted hydrocarbon radical which may be interrupted by heteroatoms and
z is 1, 2 or 3,
with the proviso that not more than two radicals R³ in formula (III) are hydrogen atoms and the radicals R^{a}_{z} represent a total of three bonds to the nitrogen, and/or hydrates thereof.

20. The process of claim 12, wherein component (D) comprises amine N-oxides of the formula
R³_{z}N═O (III),
where
the radicals R³ are identical or different and are each a hydrogen atom or an optionally substituted hydrocarbon radical which may be interrupted by heteroatoms and
z is 1, 2 or 3,
with the proviso that not more than two radicals R³ in formula (III) are hydrogen atoms and the radicals R³_{z} represent a total of three bonds to the nitrogen, and/or hydrates thereof.

21. The process of claim 14, wherein component (D) comprises amine N-oxides of the formula
R³_{z}N═O (III),
where
the radicals R³ are identical or different and are each a hydrogen atom or an optionally substituted hydrocarbon radical which may be interrupted by heteroatoms and
z is 1, 2 or 3,
with the proviso that not more than two radicals R³ in formula (III) are hydrogen atoms and the radicals R³_{z} represent a total of three bonds to the nitrogen, and/or hydrates thereof.

22. The process of claim 10, wherein component (D) is N-methylmorpholine N-oxide or N,N-dimethyldodecylamine N-oxide or a hydrate thereof

23. The process of claim 10, wherein component (D) and catalyst (C) are used in a molar ratio of from 10:1 to 1:10, based on elemental platinum.
